(19) United States
(12) Patent Application Publication
(10) Pub. No.: US 2021/0282413 A1
(43) Pub. Date: Sep. 16, 2021

(54) SORGHUM SUGAR-TAMER FOOD PRODUCT

(71) Applicant: Robert Harris, Englewood, NJ (US)

(72) Inventor: Robert Harris, Englewood, NJ (US)

(21) Appl. No.: 17/072,320

(22) Filed: Oct. 16, 2020

Related U.S. Application Data
(63) Continuation of application No. 16/818,152, filed on Mar. 13, 2020, now abandoned.

(51) Int. Cl. A21D 13/047; A21D 13/02; A23L 7/10

(52) U.S. Cl. CPC A21D 13/047; A23V 2002/00; A23L 7/10; A21D 13/02

(57) ABSTRACT

The present invention relates to food products comprising Onyx sorghum capable of moderating blood glucose and insulin levels after consumption, thereby treating or preventing diabetes, and methods for the same.

### CROSS-REFERENCE TO RELATED APPLICATION

This application claims the benefit of the filing date of U.S. application Ser. No. 16/818,152 filed Mar. 13, 2020, entitled, “SORGHUM SUGAR-TAMER FOOD PRODUCT” which is hereby incorporated by reference as if fully set forth herein.

### TECHNICAL FIELD

The present invention relates to sorghum enhanced food products capable of moderating glucose and insulin levels after consumption. Specifically, the present invention relates to food products comprising bi-colored whole-grain sorghum (commonly known as Onyx sorghum); essentially dark sorghum and high-tannin sorghum. These food products can be consumed to reduce glucose and insulin spikes, which is desirable for various reasons, including for the treatment or prevention of diabetes.

### BACKGROUND OF THE INVENTION

Red sorghum is primarily grown as animal feed in the United States. Meanwhile, white sorghum is used for gluten-free food formulations. Sorghum is a crop that lends itself to cultivation even in arid soils since it requires less moisture than most other crops and is especially appropriate in the plains, western and other aid areas of the United States. The creation of bi-colored sorghum with high-tannin bran has several benefits—namely, the ability to increase essential dietary fiber and high ORAC antioxidants to a variety of consumer diets.

The use of whole-grain, dark-colored sorghum with high-tannin bran from this grain has several benefits—namely, the ability b increase essential dietary fiber, resistant starch, and important nutrients. Unique antioxidants are also useful for glucose and insulin control. The special Onyx sorghum—whole-grain and high-tannin sorghum—impacts glucose and insulin more effectively than other grains. This was researched at Brandeis University, University of Arkansas, and is currently being studied at Yale Medical School.

Nutritionists and health professionals recommend eating whole grains, natural fiber, vegetables, fruits and ow-fat dairy products. Whole grains give one some natural fiber and important nutrients, while fruits and vegetables also provide critical fiber with a whole variety of antioxidants which are believed to help maintain good health, combat inflammation, neutralize damaging free radicals in our bodies and make other essential contributions to well-being. However, the special sorghum blend according to the present disclosure goes beyond whole-grain, such as oats and wheat, and is not available in any other product.

Certain varieties of sorghum contain proanthocyanidins (commonly referred to as tannins or more strictly-speaking condensed tannins) in the seed coat layer beneath the pericarp (commonly referred to as the testa layer) of the grain. These varieties are variously referred to as: tannin, high-tannin, brown, bird-proof, bird-resistant, or bitter sorghums. Varieties of sorghum not containing tannins are variously referred to as: non-tannin, low-tannin, condensed tannin-free, or sweet sorghums.

High tannin sorghum is sorghum with a high tannin content. Plants containing tannin may be differentiated into three categories; low tannin plants having less than 12% tannin content; average tannin plants having 12-20% tannin content; and high tannin plants having more than 20/% tannin. In addition, there are no-tannin plants.

An exciting new antioxidant known as 3-deoxyanthocyanin can be found in Onyx black sorghum as well as high tannins sorghum. This rare antioxidant has been shown to be capable of neutralizing all known free radicals.

According to recent studies, Onyx sorghum, together with condensed sorghum, contains more resistant starch than oats, wheat, and oiler whole grains. This sorghum variety contains whole-grain black sorghum and condensed tannins.

Certain benefits of consuming high tannin sorghum have been known in the art. For example, U.S. Pat. No. 8,263,167 to Harris, which is hereby incorporated by reference in its entirety, describes preparing food having an improved anti-oxidant content with high ORAC values using high tannin sorghum and 3-deoxyanthocyanin. Indeed, Silver Palate Kitchens Inc. markets various food products containing high tannin sorghum combined with 3-deoxyanthocyanins under the brand name “Grain Berry”.

On the other hand, diabetes is an extremely wide-spread problem and the incidence of diabetes has constantly increased in Europe and North America. The two most important forms are diabetes type I (approx. 5 to 10%) and diabetes type II (approx. 90%). Further, pre-diabetes is a prevalent disease among the North American population, with many people being unaware of having the condition.

The consequences of diabetes are an increase in the level of blood glucose, glucosuria and later sequelae of the increased level of blood glucose in different organ systems, disorders of lipid metabolism, etc. Depending on whether it is a question of the various damage caused by average blood sugar values being too high over many years, such as to the eyes, kidneys and nerves, or damage caused by short-term blood sugar peaks, such as premature damage to the walls of the large arterial vessels, one refers to micro- or macro-angiopathic sequelae.

Until now, therapies for disorders of blood sugar metabolism have basically been limited to increasing the content of insulin in the blood (by administering insulin or by enhancing the excretion of insulin) and enhancing the efficiency of insulin. An alternative approach is to delay the uptake of carbohydrates (agent for delaying absorption), but this leads to abdominal pain due to the bacterial degradation of carbohydrates that accumulate in the lower sections of the intestines.

Despite all methods found to date for treating diabetes, there is still a need for methods that prevent or reduce the increase in the level of blood sugar as a result of food consumption, without placing a burden on the body.

It would therefore be desirable to provide an ingredient that can be utilized in the preparation of food products so that consuming said food products may moderate glucose and insulin levels after consumption. It would further be desirable to provide a method to moderate glucose and insulin levels by simply consuming food. It would also be desirable to provide a method to treat or to prevent diabetes by consuming food that does not result in glucose and insulin spikes after consumption.

### SUMMARY OF THE INVENTION

The above objectives can be achieved by administering to a subject in need thereof food products comprising Onyx sorghum. By substituting refined grain or whole grain flour with an effective amount of Onyx sorghum, the resulting food products are capable of moderating glucose and insulin levels after consumption.

### BRIEF DESCRIPTION OF THE DRAWINGS

The accompanying drawings illustrate the present invention and together with the description, further serve to explain the principles of the invention and to enable a person skilled in the relevant art to make and use the invention.

These and other features and advantages of the present invention will be apparent from the following detailed description, claims, and accompanying drawings.

FIG. 1 is a diagram showing the incremental plasma glucose response of subjects having consumed food products containing whole wheat versus Onyx sorghum.

FIG. 2 is a diagram showing the incremental plasma insulin response of subjects having consumed food products containing whole wheat versus Onyx sorghum.

### DETAILED DESCRIPTION

While this invention is susceptible of embodiments in many different forms, there are shown in the drawings and will be described in detail herein specific embodiments with the understanding that the present disclosure is to be considered as an exemplification of the principles of the invention. It is not intended to limit the invention to the specific illustrated embodiment.

The features of the invention disclosed herein in the description, drawings, and claims can be significant, both individually and in any desired combinations, for the operation of the invention in its various embodiments. Features from one embodiment can be used in other embodiments of the invention.

In accordance with the subject disclosure, it has been found that Onyx sorghum, when used in food products, may moderate blood glucose levels after consumption, thereby provides an effective mean to prevent or treat diabetes, as set forth in the examples below.

For the purpose of his disclosure, the term “Onyx sorghum” refers to a sorghum blend comprising black sorghum and condensed tannins. More specifically, Onyx sorghum has a tannin content of over 20%. Preferably, the tannin content ranges between 20% to 30%, and more precisely, 20% to 25%.

### Example 1

Example 1 demonstrates the surprisingly effectiveness of Onyx sorghum in moderating glucose and insulin levels when used in food products. Without wishing to be bound by any theory, it is supposed that this effectiveness is due to Onyx sorghum containing an unexpectedly high amount of resistant starch than whole wheat, and far higher than white refined flour. Thus it is supposed that the moderation of glucose and insulin levels is achieved through resistant starch, low glycol-load, and avoidance of sugar spikes.

In general, dietary starches can be classified into three major fractions according to in vitro digestibility as rapidly digestible (RDS), slowly digestible (SDS), and resistant starch (RS). RDS is hydrolyzed into glucose within 20 minutes; SDS is hydrolyzed into glucose between 20 and 120 minutes; and RS remains undigested after 120 minutes after consumption. Studies have shown that consuming food rich with RS may provide significant health benefits. Patindol et al., “Nutritionally Important Starch Fractions Of Rice Cultivars Grown In Southern United States”, Journal of Food Science Food, Volume 75(5) (June 2010), H137-44, which is hereby incorporated by reference in its entirety.

Using Onyx sorghum—a high tannin sorghum developed by Texas A&M University—as an example, it has been shown that Onyx sorghum muffins contain significantly higher RS content than whole wheat muffins with similar compositions.

TABLE 1
In vitro total starch and starch fraction
measurement of wheat and ONYX muffins

| Starch composition | Whole Wheat muffins | ONYX Sorghum muffins |
|---|---|---|
| TS % | 54.5 ± 1.7 | 54.3 ± 1.4 |
| RDS % | 76.8 ± 6.5 | 69.2 ± 7.5 |
| SDS % | 17.0 ± 3.7 | 18.9 ± 4.4 |
| RS % | 2.8 ± 0.0 | 4.2 ± 0.1* |

RDS, SDS, and RS percentages are based on TS. Data are expressed as Mean ± SD (standard deviation). N = 2-4.
*indicates P < 0.05 significance.

By way of example, Onyx sorghum may be incorporated into bake goods such as a muffin. For the compositions shown in Table 1, two muffins which contained a total serving of 50 g of total starch were used. All taw materials were weighted separately for each treatment as shown in Table 2 below.

TABLE 2
Muffin ingredients

| Ingredient | Whole Wheat muffins (g) | ONYX Sorghum muffins (g) |
|---|---|---|
| Flour | 93.9 | 85.8 |
| Water | 65.9 | 80 |
| Egg | 38.8 | 38.8 |
| Butter | 20.0 | 20.0 |
| Vegetable oil | 7.5 | 7.5 |
| Sucralose | 3.0 | 3.0 |
| Salt | 1.3 | 1.3 |
| Baking powder | 1.8 | 1.8 |

By administering muffins containing Onyx sorghum according to an exemplary embodiment, remarkable results were obtained in that incremental glucose responses and incremental insulin concentrations were significantly lower when muffins containing Onyx sorghum were consumed versus when whole wheat muffins were consumed.

In particular, twelve participants were selected after a screening session. Five participants identified themselves as Asian or Asian American, three as Caucasian, two as African or African American, and two as Latino/Hispanic. The breakdowns of these participants are shown in Table 3 below.

TABLE 3
Participant information

| | Participants (n = 12) |
|---|---|
| Age | 26.7 ± 4.9 |
| BMI (Body Mass Index, kg/m²) | 26.8 ± 3.7 |
| Fasting blood glucose levels (mg/dL) | 90.3 ± 5.1 |

Data are expressed as Mean ± SD (standard deviation).

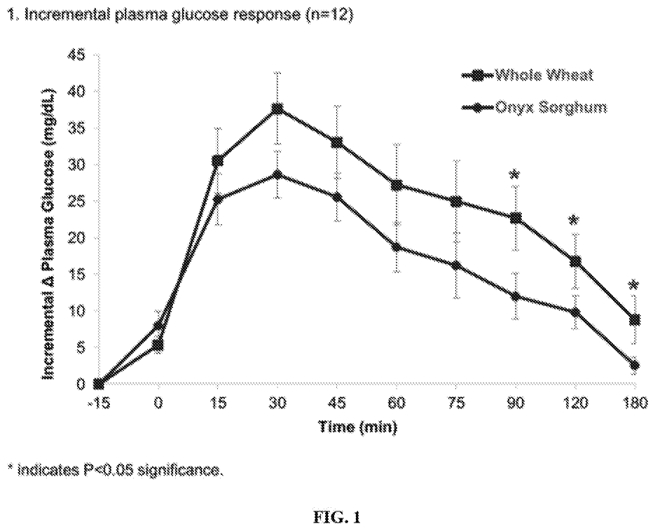

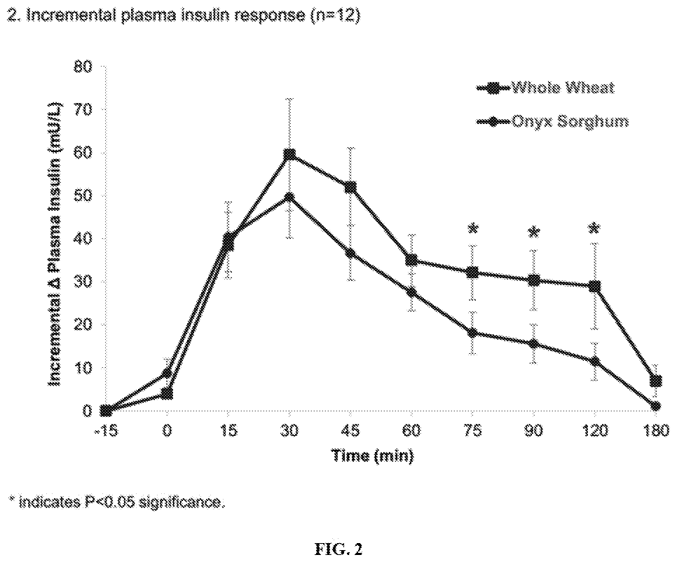

The differences between consuming whole grain muffins versus muffins containing Onyx sorghum are statistically significant (p<0.05) as shown in FIG. 1 and FIG. 2. Further, as shown in Table 3 below, the incremental glucose responses with sorghum muffin treatment were significantly lower at 90, 120, and 180 minutes intervals (P<0.05). Likewise, incremental insulin concentrations for sorghum muffin treatment were significantly lower at 75, 90, and 120 minutes (P<0.05).

TABLE 3
Mean incremental area under the curves (iAUC)
for plasma glucose and insulin responses

| | Participants | Whole Wheat | ONYX Sorghum |
|---|---|---|---|
| Glucose iAUC | 12 | 3911 ± 589 | 2626 ± 342* |
| (mg · (~3 h)/dL) | | | |
| Insulin iAUC | 12 | 5510 ± 1088 | 3617 ± 683* |
| (μU · (~3 h)/L) | | | |

Data are expressed as Mean ± SD (standard deviation).
*indicates P < 0.05 significance.

As shown in Table 3 above, with the muffin treatment according to the exemplary embodiment, mean iAUC (incremental area under the curve) responses of glucose were significantly reduced about 33% (P<0.05). Mean iAUC responses of insulin were also significantly reduced about 34%(P<0.05).

Although the exemplary embodiment describes utilizing Onyx sorghum in the form of a muffin to moderate glucose or insulin levels, those skilled in the art would readily appreciate that Onyx sorghum may be applied to many other food products to achieve similar effects. Other food products may include, but are not limited to, bake goods, pancake or waffle mix, sauces, pastas, cereals, beverages, soups, gravies, eggs, or salads. By way of example, numerous food recipes utilizing high tannin sorghum were described in U.S. Pat. No. 8,263,167 to Harris. Such other food products utilizing Onyx sorghum b moderate glucose or insulin levels are intended to be part of this disclosure and within the spirit and scope of this invention.

Further, although the exemplary embodiment describes muffins having an Onyx sorghum blend content of about 30% to 40%, and more precisely, 36%. A skilled artisan would readily appreciate that flour made out of Onyx sorghum can be used to replace conventional flour in other applications to achieve this remarkable result. As such, this embodiment is merely an example, and does not intend to limit the scope of this invention to only food products containing the same percentage of sorghum blend content.

Moreover, a skilled artisan can also appreciate that while it is preferred to completely replace conventional flour with Onyx sorghum in a food product recipe—i.e., replacing 100% of flour in a recipe with Onyx sorghum—to achieve maximum effect in moderating glucose or insulin levels, replacing only part of the flour can also achieve some amount of glucose and insulin moderation, so long as the Onyx sorghum content is not merely de minimis. For example, cereals and other products, such as bread, can also benefit from the inclusion of Onyx sorghum blend.

For the purpose of this disclosure, it is contemplated that food products containing more than 3.5% Onyx blend sorghum would be effective in moderating glucose or insulin level in a subject. While it is preferred to have Onyx sorghum blend completely replacing flour within a food product, it is intended to be part of this disclosure and within the spirit and scope of this invention that Onyx sorghum blend can be used to replace all or part of the flour called for in a recipe.

### Example 2

Example 2 demonstrates the effectiveness of a Onyx sorghum blend diet in Nile rats to control diabetes. Specifically, it was found that rats fed with Onyx sorghum blend experienced a significant reduction in blood glucose after eight weeks as shown in Table 4 below.

TABLE 4
Diabetes in 3 wk old male Nile rats fed with hiCHO diet
without flour (control diet) or with wheat flour or
sorghum flour for 8 wks (NR study 127 A, unsplit)

| | #73 MB | #162 | #163 |
|---|---|---|---|
| | HiCHO | Wheat | ONYX Sorghum |
| Diet | Control | flour | flour |
| CHO:Fat:Prot % E | 70:10:20 | 70:10:20 | 70:10:20 |
| (Fat/Prot % E ratio) | (0.5) | (0.5) | (0.5) |
| Glycemic Load/ | 285 | 238 | 197 |
| 2000 kcal | | | |
| kcal/g | 4.1 | 4.0 | 3.7 |
| OGTT 30 min | 2/10 (83%) | 5/7 (58%) | 8/5 (38%) |
| <150 mg/dl> 8 wk | | | |
| T2DM | | | |
| (% incidence)* | | | |
| RBG <75 mg/dl> | 5/7 (58%) | 5/7 (58%) | 9/4 (31%) |
| 8 wk T2DM | | | |
| (% incidence)** | | | |
| FBG <60 mg/dl> | 5/7 (58%) | 7/5 (42%) | 11/2 (15%) |
| terminal T2DM | | | |
| (% incidence)*** | | | |
| Body weight (g) | | | |
| Initial | 43 ± 5 | 42 ± 4 | 42 ± 5 |
| After 4 wks | 82 ± 8^{a,b} | 75 ± 6^{a} | 76 ± 8^{b} |
| After 8 wks | 96 ± 9 | 95 ± 9 | 90 ± 11 |
| Food Intake | | | |
| g/d | 9.5 ± 1.1^{a,b} | 8.0 ± 0.5^{a,c} | 10.5 ± 1.0^{b,c} |
| kcal/d | 39 ± 5^{a} | 31 ± 2^{a,b} | 38 ± 4^{b} |
| Food Efficiency (g | 25 ± 4^{a} | 31 ± 7^{a,b} | 22 ± 5^{b} |
| BW gain/1000 kcal) | | | |
| Random blood | | | |
| glucose (mg/dL) | | | |
| After 4 wks | 148 ± 119 | 119 ±130 | 69 ± 14 |
| After 8 wks | 242 ± 199^{a} | 139 ± 151 | 83 ± 61^{a} |
| Fasting blood | | | |
| glucose (mg/dL) | | | |
| Terminal after | 65 ± 28 | 59 ± 23 | 44 ± 13 |
| 8 wks | | | |
| OGTT, after 4 | | | |
| wks (mg/dL) | | | |
| 0 min | 48 ± 10 | 45 ± 11 | 56 ± 20 |
| 30 min | 225 ± 87^{a} | 170 ± 103 | 133 ± 52^{a} |
| OGTT, after 8 | | | |
| wks (mg/dL) | | | |
| 0 min | 53 ± 20 | 42 ± 18 | 44 ± 9 |
| 30 min | 266 ± 110^{a} | 190 ± 107 | 150 ± 67^{a} |
| Organ weight | | | |
| % BW | | | |
| Liver | 3.52 ± 0.44^{a,b} | 2.94 ± 0.49^{a} | 2.66 ± 0.26^{b} |
| Kidney | 0.74 ± 0.14^{a} | 0.67 ± 0.13 | 0.62 ± 0.06^{a} |
| Cecum | 1.22 ± 0.35 | 1.35 ± 0.55 | 1.25 ± 0.16 |
| Adipose | | | |
| EPI | 2.88 ± 0.83 | 2.95 ± 0.82 | 2.82 ± 0.72 |
| PERI | 1.33 ± 1.10 | 1.56 ± 0.90 | 1.42 ± 0.55 |
| Brown | 1.82 ± 0.44 | 1.67 ± 0.52 | 1.53 ± 0.46 |
| Total fat | 5.94 ± 1.92 | 6.19 ± 1.86 | 5.78 ± 1.26 |
| (EPI + | | | |
| PERI + Brown) | | | |
| Carcass | 70 ± 2 | 69 ± 2^{a} | 72 ± 4^{a} |
| Body length (cm) | 13.9 ± 0.4 | 13.7 ± 0.5 | 13.6 ± 0.5 |
| Plasma lipids, | | | |
| terminal (mg/dL) | | | |
| TC | 157 ± 127 | 105 ± 95 | 105 ± 44 |
| TG | 67 ± 22 | 70 ± 23 | 53 ± 14 |

Data are expressed as Mean ± SD (standard deviation) (n = 12-13).
^{a,b,c}Means in a row sharing common superscript differ (P < 0.05) using one-way ANOVA and Fisher's PLSD
*% Incidence <150 mg/dl> based on OGTT 30′ after 8 wk on diet.
**% Incidence <75 mg/dl> based on RBG after 8 wk on diet (best predictor of T2DM found at necropsy).
***% Incidence <60 mg/dl> based on FBG after 8 wk on diet.

As shown in the above example, rats fed with a bend of rat chow and Onyx sorghum showed surprising reductions in blood glucose levels in comparison to rats on the control diet or on the whole wheat diet. As such, a diet of Onyx sorghum blend, whole grain oats, and wheat may be utilized as a method for treating or preventing diabetes.

Although the above description is generally directed to methods of treating or preventing diabetes and to moderate glucose and insulant levels, Onyx sorghum blend may also be suitable for other purposes due to its unexpectedly high amount of RS. For example, studies have shown that RS having beneficial impacts in the prevention of cancer, postprandial glycaemia and insulinemia, hyperlipidemia, gall stone formation, and cardiovascular diseases. Such other methods of treatment utilizing high RS concentration of Onyx sorghum are intended to be part of this disclosure and within the spirit and scope of this invention.

Having thus described several aspects of at least one embodiment of this invention, it is to be appreciated that various alterations, modifications and improvements will readily occur to those skilled in the art. Such alterations, modifications and improvements are intended to be part of this disclosure, and are intended to be within the spirit and scope of the invention. Accordingly, the foregoing description and drawings are by way of example only.

1. A method for treating diabetes comprising:
administering to a subject in need thereof a first food product in the form of baked goods including onyx sorghum that is of about 30% to 40% by weight of ingredient,
wherein the onyx sorghum is used to replace all or part of flour required to produce the first food product, and wherein blood glucose levels of the subject are lower after consuming the first food product as opposed to consuming a second food product not containing onyx sorghum.

2-10. (canceled)
